(19) United States
(12) Patent Application Publication
(10) Pub. No.: US 2006/0233452 A1
(43) Pub. Date: Oct. 19, 2006

(54) Text enhancement methodology in scanned images of gray-scale documents

(76) Inventor: Mine-Ta Yang, Hsin-Chu (TW)

Correspondence Address: Raymond Y. Chan, Suite 128, 108 N. Ynez Ave., Monterey Park, CA, 91754, US

(21) Appl. No.: 11/105,727

(22) Filed: Apr. 13, 2005

(51) Int. Cl. G06K 9/40

(52) U.S. Cl. 382/254

(57) ABSTRACT

The present invention is to provide a text enhancement methodology of gray-scale levels of a scanned image so as to enhance text legibility. The text enhancement methodology includes the following steps of: utilizing a window block pattern as a fumdamental processing unit to read the scanned image, wherein the window block pattern comprises at least two pixels in a predetermined neighborhood; analyzing the scanned image in the window block pattern to find right, left, upper, and bottom edges; labeling the image in the window block pattern as two groups of text pixels and non-text pixels based on the window block pattern and the right, left, upper, and bottom edges; and enhancing the text pixels/non-text pixels of scanned image in the window block pattern based on the window block pattern and the right, left, upper, and bottom edges.

### BACKGROUND OF THE PRESENT INVENTION

1. Field of Invention

The present invention relates to an image processing methodology, and more particularly to a methodology for recognizing and enhancing the legibility of text in a scanned image of a document, which renders the avail of expeditious and accurate recognition of text in addition to the advantage of the easy user-defined setup to procure various degrees of recognition and enhancement output without the complex arithmetic, massive computation, and data storage loading.

2. Description of Related Arts

With the advance of information technology, notably among image processing technology, the need for scanning images from hardcopy at an attempt to be processed in digital environment has been ever increasing. Successful and effective scanning technology converts texts and graphics on the tangible objects into digital files in computer. Hence industrial utilization of computers is greatly enhanced, which may be programmed to generate a tailor-made image or a combination of graphics so as to optimally apply to different business or industrial circumstances.

The vast majority of documents consist of a mixture of background, texts, and graphics in various colors. For simple documents, such as a typical white-black document, the texts (usually black in color) and the background (usually white in color) can be separated rather easily so that the texts in that document are highly recognizable. While a number of documents fall into this white-black category, yet an even more considerable number of documents consist of complicated mixture of texts, graphics and finely decorated background. As a result, it would be very difficult to separate the text from the background and the graphics, especially when the documents are scanned where the color of the text, background as well as the graphics are usually distorted on account of the imperfection in scanning technique, and therefore making it even more difficult to develop any method or algorithm to distinguish and identify only the text from other parts of the relevant document.

As a matter of conventional art, several methods and algorithms are elaborated to approach the desire of recognizing texts from a mixture of text, background and graphics. For example, U.S. Pat. No. 6,227,725 discloses a method of printing documents, comprising a step of receiving a source image signal and processing the source image signal into an output image signal composing of a plurality of pixels.

It can be seen from the '725 patent that the method involves a labeling operation that includes a first labeling step in which a plurality of the pixels from the output image of the first labeling step are labeled as text pixels, subject to a condition that a pixel from the output image of the first labeling step is labeled as a text pixel in the first labeling step only if the intensity of the subject input pixel to which that output pixel corresponds is less than an intensity threshold and the gradient at least at one pixel in a predetermined neighborhood of the subject input pixel is greater than a predetermined gradient threshold that exceeds the gradient at the subject pixel. Moreover, the labeling operation further includes a label-refining step in which each pixel labeled as a text pixel in the first labeling step is re-classified as a non-text pixel if adjacent row and column pixels of that pixel are each non-text pixels and no diagonally opposite pixel pair are text pixels.

The main disadvantage of this method as revealed in the '725 patent is that in order to enhance the contrast between the texts and the background as well as the graphics, each of the pixels must undergo the above-mentioned labeling operation so as to compare an intensity of the pixel with a threshold intensity. As such, this labeling operation would inevitably consume a considerable amount of memory resources so that the acquisition of the effective recognition on texts from a mixture of texts, background and graphics signifies a considerable amount of time to be expended.

On the other hand, U.S. Pat. No. 5,280,367 discloses a method of enhancing data which is rendered as a bi-tonal bit-mapped image for subsequent printing on a printer. The method involves the steps of (a) receiving a source bit-mapped image at a first resolution for printing on a printer at a second resolution which is higher than the first resolution, wherein the source bit-mapped image has a plurality of elements; (b) convoluting the source bit-mapped image with a gradient operator to generate at least one gradient value for each element of the source bit-mapped image, and (c) expanding each element of the source bit-mapped image by a predetermined factor to produce an expanded bit-mapped image. Basically, a pixel is divided into a plurality (usually four) parts wherein the gradient value for each pixels is calculated. After that, the relevant pixels are highlighted by a predetermined factor so as to enhance contrast between text, background and graphics on a scanned image.

Again, a major disadvantage of this method is that it involves complicated calculation for each of the pixels so that it necessarily delays the speed of image processing while it does not guarantee the quality of text-background or text-graphics separation contrasting.

Other text enhancement methods include convolution operation (U.S. Pat. No. 5,946,420 of Noh), high frequency domain operation (U.S. Pat. No. 6,185,329 Zhang et al.), as well as histogram operation (U.S. Pat. No. 5,280,367 of Zuniga). All of these methods have a common problem of high computing resources requirement, yet some of them have the additional problem of poor or unsatisfactory performance/effectiveness.

### SUMMARY OF THE PRESENT INVENTION

A main object of the present invention is to provide an efficient and accurate text enhancement methodology, wherein the methodology is capable of offering the expeditious identification and enhancement results with easy-to-implement algorithm, fast arithmetic process, and reasonable low-cost hardware dependency.

Another object of the present invention is to provide a text enhancement methodology of gray-scale levels of a scanned image with a white background (or light background) in RGB domain or solely gray-scale domain, wherein the window block size could be as diverse as a two-pixel window block, a three-pixel window block, or even a multiple-pixel window block, depending on how much information the central pixel wants to take into concern from other pixels in the vicinity to decide the execution on itself, wherein the window block size in the present invention is regulated at a 3-pixel block size which maintains a good balance between the enhancement accuracy and the processing efficiency.

Another object of the present invention is to provide a text enhancement methodology of gray-scale levels of a scanned image in RGB domain or solely gray-scale domain, wherein the window block shape could be either, not limited to, 2-pixel in-line shape, or 3-pixel L-shape, depending on the characteristics of the input source image and the pattern and distribution of the text objects in the background, to the effect that the maximum enhancement and the text identification could be achieved.

Another object of the present invention is to provide a text enhancement methodology of gray-scale levels of a scanned image in RGB domain or solely gray-scale domain, wherein the text enhancement methodology is applicable to light-text dark-background objects, dark-text light-background objects, and even to the text in multicolored or grayscale background, with the proper adjustment in the values of initial thresholds, judgment thresholds, edge enhancement thresholds, and text interior thresholds based on the objects characteristics and color distribution pattern.

Another object of the present invention is to provide a text enhancement methodology of gray-scale levels of a scanned image in RGB domain or solely gray-scale domain, wherein a set of initial thresholds and a set of judgment thresholds serve the purpose of decision-making whether or not the values of central pixel in the color space should undergo the enhancement procedures while the edge enhancement thresholds and the text interior enhancement thresholds determine the amount of values which should be increased or decreased from the values of central pixel so as to reach the enhancement results, wherein each set of thresholds and pixels may be represented in three sets of values ranging from 0 to 255 in a RGB color space, other type of representations which are capable of expressing the entire color space, or a gray-scale level consisting of 16 possible levels with zero being pure black and 15 being pure white.

Another object of the present invention is to provide a text enhancement methodology of gray-scale levels of a scanned image in RGB domain or solely gray-scale domain, wherein the first-stage edge detection and the first-stage edge enhancement in the dark-text light-background objects perform the procedures categorized in the following four groups: A). in the 3-pixel triangle window block by the upper adjacent pixel, the left adjacent pixel, and the central pixel, the lightening edge enhancement is executed when the right- and/or bottom edge is detected. B). in the 3-pixel triangle window block by the upper adjacent pixel, the right adjacent pixel, and the central pixel, the lightening edge enhancement is executed when the left- and/or bottom edge is detected. C). in the 3-pixel triangle window block by the lower adjacent pixel, the right adjacent pixel, and the central pixel, the lightening edge enhancement is executed when the left- and/or upper-edge is detected. D). in the 3-pixel triangle window block by the lower adjacent pixel, the left adjacent pixel, and the central pixel, the lightening edge enhancement is executed when the right- and/or upper-edge is detected.

Another object of the present invention is to provide a text enhancement methodology of gray-scale levels of a scanned image in RGB domain or solely gray-scale domain, wherein the second-stage edge detection and the second-stage edge enhancement in the dark-text light-background objects perform the procedures categorized in the following four groups: A). in the 3-pixel triangle window block by the upper adjacent pixel, the left adjacent pixel, and the central pixel, the darkening edge enhancement is executed when the left- and/or upper-edge is detected. B). in the 3-pixel triangle window block by the upper adjacent pixel, the right adjacent pixel, and the central pixel, the darkening edge enhancement is executed when the right- and/or upper-edge is detected. C). in the 3-pixel triangle window block by the lower adjacent pixel, the right adjacent pixel, and the central pixel, the darkening edge enhancement is executed when the right- and/or bottom edge is detected. D). in the 3-pixel triangle window block by the lower adjacent pixel, the left adjacent pixel, and the central pixel, the darkening edge enhancement is executed when the left- and/or bottom edge is detected.

Another object of the present invention is to provide a text enhancement methodology of gray-scale levels of a scanned image in RGB domain or solely gray-scale domain, wherein the first-stage edge detection and the first-stage edge enhancement in the light-text dark-background objects perform the procedures categorized in the following four groups: A). in the 3-pixel triangle window block by the upper adjacent pixel, the left adjacent pixel, and the central pixel, the darkening edge enhancement is executed when the right- and/or bottom edge is detected. B). in the 3-pixel triangle window block by the upper adjacent pixel, the right adjacent pixel, and the central pixel, the darkening edge enhancement is executed when the left- and/or bottom edge is detected. C). in the 3-pixel triangle window block by the lower adjacent pixel, the right adjacent pixel, and the central pixel, the darkening edge enhancement is executed when the left- and/or upper-edge is detected. D). in the 3-pixel triangle window block by the lower adjacent pixel, the left adjacent pixel, and the central pixel, the darkening edge enhancement is executed when the right- and/or upper-edge is detected.

Another object of the present invention is to provide a text enhancement methodology of gray-scale levels of a scanned image in RGB domain or solely gray-scale domain, wherein the second-stage edge detection and the second-stage edge enhancement in the dark-text light-background objects perform the procedures categorized in the following four groups: A). in the 3-pixel triangle window block by the upper adjacent pixel, the left adjacent pixel, and the central pixel, the lightening edge enhancement is executed when the left- and/or upper-edge is detected. B). in the 3-pixel triangle window block by the upper adjacent pixel, the right adjacent pixel, and the central pixel, the lightening edge enhancement is executed when the right- and/or upper-edge is detected. C). in the 3-pixel triangle window block by the lower adjacent pixel, the right adjacent pixel, and the central pixel, the lightening edge enhancement is executed when the right- and/or bottom edge is detected. D). in the 3-pixel triangle window block by the lower adjacent pixel, the left adjacent pixel, and the central pixel, the lightening edge enhancement is executed when the left- and/or bottom edge is detected.

Another object of the present invention is to provide a text enhancement methodology of gray-scale levels of a scanned image in RGB domain or solely gray-scale domain, wherein the first-stage edge detection could perform a darkening function and the second-stage edge detection could perform a lightening function, or vice versa, the first-stage edge detection performs the lightening function and the second-stage edge detection performs the darkening function, which the change of the order of the procedures has no influence on the consequence of the enhancement methodology.

Another object of the present invention is to provide a text enhancement methodology of gray-scale levels of a scanned image in RGB domain or solely gray-scale domain, wherein the selection of the window block shape affects the edge enhancement decision to be the darkening execution or the lightening execution on the first- and second-stage edge enhancement, however, the final edge enhancement result is equally the same, only the procedure order changes.

Another object of the present invention is to provide a text enhancement methodology of gray-scale levels of a scanned image in RGB domain or solely gray-scale domain, wherein the renormalization verifies each pixel after being processed is within the logical value according to the representation of the coordinates in color space so as to avoid the error of light spots in each pixel after the enhancement.

Another object of the present invention is to provide a window block, wherein the numbers of the pixels in each of the window block as the fundamental processing unit is the factor to determine the speed of fetching window blocks from the source image, to affect the enhancement value of the central pixel in the window block by considering distant pixels and adjacent pixels in different weighting function to calculate the influence on that central pixel, and to increase the processing loading for computing more data if the larger size of the window block is chosen so that the careful selection of the size of the window block should be adjustable on the basis of the application requirement and the complexity of the graphic-text-separation object.

Another object of the present invention is to provide an edge detection methodology, wherein if satisfying the two conditions in the dark-text light-background objects: A). the RGB values in the central pixel are more than the amount of the light initial thresholds which is determined on the basis of the application's background and the gray-scale level of text; B) the RGB values in the central pixel are more than the RGB values in the adjacent pixel by no less the amount of the light judgment thresholds which is also determined on the basis of the application's background and the gray-scale level of text, the edge from the text objects toward the background is thereupon detected.

Another object of the present invention is to provide an edge detection methodology, wherein if satisfying the two conditions in the dark-text light-background objects: A). the RGB values in the central pixel are fewer than the amount of the dark initial thresholds which is determined on the basis of the application's background and the gray-scale level of text; B) the RGB values in the central pixel are fewer than the RGB values in the adjacent pixel by no less than the amount of the dark judgment thresholds which is also determined on the basis of the application's background and the gray-scale level of text, the edge from the background toward the text objects is thereupon detected.

Another object of the present invention is to provide an edge detection methodology, wherein if satisfying the two conditions in the light-text dark-background objects: A). the RGB values in the central pixel are fewer than the amount of the dark initial thresholds which is determined on the basis of the application's background and the gray-scale level of text; B) the RGB values in the central pixel are fewer than the RGB values in the adjacent pixel by no less than the amount of the light judgment thresholds which is also determined on the basis of the application's background and the gray-scale level of text, the edge from the text objects toward the background is thereupon detected.

Another object of the present invention is to provide an edge detection methodology, wherein if satisfying the two conditions in the light-text dark-background objects: A). the RGB values in the central pixel are more than the amount of the light initial thresholds which is determined on the basis of the application's background and the gray-scale level of text; B) the RGB values in the central pixel are more than the RGB values in the adjacent pixel by no less the amount of the light judgment thresholds which is also determined on the basis of the application's background and the gray-scale level of text, the edge from the background toward the text objects is thereupon detected.

Another object of the present invention is to provide an edge enhancement, wherein the RGB values in the pixel is increased or decreased by the amount of the dark edge enhancement thresholds so as to darken the pixel to distinguish from other pixels in the vicinity.

Another object of the present invention is to provide an edge enhancement, wherein the RGB values in the pixel is decreased or increased by the amount of the light edge enhancement thresholds so as to lighten the pixel to distinguish from other pixels in the vicinity.

Another object of the present invention is to provide the text interior enhancement, wherein if the pixel is recognized as the text interior pixel within the area of the edge pixels in the dark-text light-background system, the RGB values in the pixel is decreased respectively so as to darken the pixel to emphasize the contrast between the text pixel and the background pixel.

Another object of the present invention is to provide the text interior enhancement, wherein if the pixel is recognized as the text interior pixel within the area of the edge pixels in the light-text dark-background system, the RGB values in the pixel is increased so as to lighten the pixel to emphasize the contrast between the text pixel and the background pixel.

Accordingly, in order to accomplish the above object, the present invention is to provide a text enhancement methodology of gray-scale levels of a scanned image, comprising the steps of:

a) utilizing a window block pattern as a fundamental processing unit to read the scanned image, wherein the window block pattern comprises at least two pixels in a predetermined neighborhood;

b) analyzing the scanned image in the window block pattern to find right, left, upper, and bottom edges;

c) labeling the image in the window block pattern as two groups of text pixels and non-text pixels based on the window block pattern and the right, left, upper, and bottom edges; and

d) enhancing the text pixels/non-text pixels of scanned image in the window block pattern based on the window block pattern and the right, left, upper, and bottom edges.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic diagram of detecting a right edge, a bottom edge, a left edge, and an upper edge with a mirrored 3-pixel L-shape window block according to a preferred embodiment of the present invention.

FIG. 2 is a flowchart of the text enhancement methodology of gray-scale levels of a scanned image with a white background (or light background) in RGB domain or solely gray-scale domain according to the above preferred embodiment of the present invention.

FIG. 3 is a possible set of window blocks of the text enhancement methodology of gray-scale levels of a scanned image with a white background (or light background) in RGB domain or solely gray-scale domain according to a preferred embodiment of the present invention.

FIG. 4 is an alternative flowchart of the text enhancement methodology of gray-scale levels of a scanned image with a white background (or light background) in RGB domain or solely gray-scale domain according to a preferred embodiment of the present invention.

FIG. 5 is an unprocessed source image.

FIG. 6 is an enhanced image with the text methodology of the present invention.

### DETAILED DESCRIPTION OF THE PREFERRED EMBODIMENT

The following description is one of the best presently contemplated mode of carrying out the present invention. This description is not to be taken in a limiting sense but is made merely for the purpose of describing the general principles of the invention. The scope of the invention should be determined by referencing the appended claims.

The present invention is used to provide a text enhancement methodology of gray-scale levels of a scanned image with a white background (or light background) in RGB domain or solely gray-scale domain. Especially, the present invention's teachings mainly are applied to a black text of a scanned image on a white background (or light background) either in RGB domain or solely gray-scale domain. If in RGB domain, that is, for each of a plurality of pixels into which the image is divided, the raw digital image includes a digital value for each of a plurality of color components. These components are typically red, green, and blue, in which case maximum white in an eight-bit-per-component system is (255, 255, 255), maximum black is (0, 0, 0), and maximum red is (255, 0, 0). Although we assume a color image, it will become apparent that the present invention's teachings apply particularly to documents in which the text itself is black or dark gray on a white background (or light background).

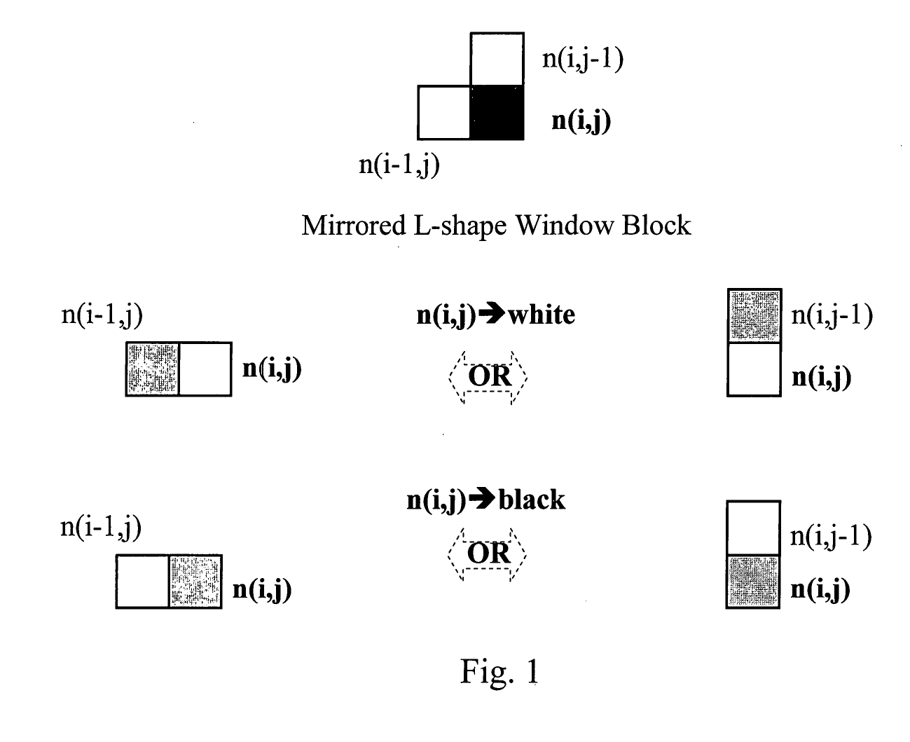

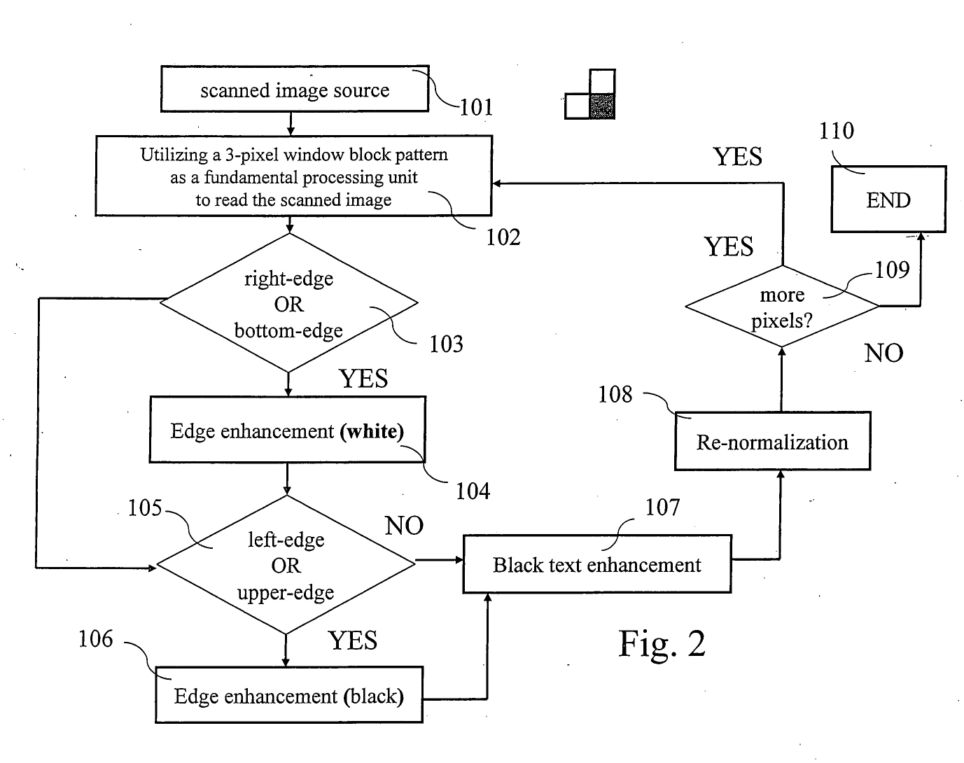

Please refer to FIG. 1, is a schematic diagram of detecting a right edge, a bottom edge, a left edge, and an upper edge with a mirrored 3-pixel L-shape window block according to a preferred embodiment of the present invention. When a mirrored 3-pixel L-shape window block is applied to the text enhancement, a flowchart of the text enhancement methodology of gray-scale levels of a scanned image with a white background (or light background) in RGB domain or solely gray-scale domain according to a preferred embodiment of the present invention is shown in FIG. 2. Referring to FIG. 2, the first step of executing the text enhancement is to acquire a scanned image which could be processed from a scanner, a digital camera, or any other type of multimedia applications. After acquiring a scanned image as indicated by symbol 101, a window block pattern is utilized as a fundamental processing unit to read the scanned image. In this embodiment, the mirrored 3-pixel L-shape window block is utilized as a fundamental processing unit in which the mirrored 3-pixel L-shape window block comprises a central pixel at location (i, j), an upper adjacent pixel at location (i, j−1), and a left adjacent pixel at location (i−1, j). Symbol 103 performs a right-edge or a bottom-edge detection to determine whether the pixels satisfy the necessary conditions or not. The right-edge detection conditions are described as below. A value of the central pixel at location (i, j) is greater than a predetermined initial threshold, assumed 150, the central pixel value is greater than a value of the left adjacent pixel at location (i−1, j), and a difference between the central pixel value at location (i, j) and the left adjacent pixel value at location (i−1, j) is greater than a predetermined judgement threshold. In other words, the RGB value of the central pixel at location (i, j) is greater than the RGB value of the left adjacent pixel at location (i−1, j) individually. In addition, the difference between the RGB value of the central pixel at location (i, j) and the RGB value of the left adjacent pixel at location (i−1, j) is greater than a predetermined judgement threshold, assumed 30, individually. The edge enhancement is executed by adding a predetermined value, assumed 150, to the RGB value of the central pixel at location (i, j) so as to execute lightening enhancement of the central pixel at location (i, j). The right-edge detection conditions could be expressed by the following equations.
n(i, j)R>initial threshold (assumed 150) (1)
n(i, j)G>initial threshold (assumed 150) (2)
n(i, j)B>initial threshold (assumed 150) (3)
n(i, j)R>n(i−1, j)R (4)
n(i, j)G>n(i−1, j)G (5)
n(i, j)B>n(i−1, j)B (6)
n(i, j)R−n(i−1, j)R>judgement threshold (assumed 30) (7)
n(i, j)G−n(i−1, j)G>judgement threshold (assured 30) (8)
n(i, j)B−n(i−1, j)B>judgement threshold (assumed 30) (9)

Where n(i, j)R represents the RGB value of the central pixel at location (i, j) in red, n(i, j)G represents the RGB value of the central pixel at location (i, j) in green, n(i, j)B represents the RGB value of the central pixel at location (i, j) in blue, n(i−1, j)R represents the RGB value of the left adjacent pixel at location (i−1, j) in red, n(i−1, j)G represents the RGB value of the left adjacent pixel at location (i−1, j) in green, and n(i−1, j)B represents the RGB value of the left adjacent pixel at location (i−1, j) in blue.

Therefore, symbol 104 performs the lightening enhancement of the central pixel at location (i, j) if the pixels satisfy the right-edge detection conditions. The lightening enhancement of the central pixel at location (i, j) could be expressed by the following equations.
n(i, j)R+a predetermined value (assumed 150) (10)
n(i, j)G+a predetermined value (assumed 150) (11)
n(i, j)B+a predetermined value (assumed 150) (12)

The bottom-edge detection is similar to the above description. The bottom edge is detected and lightening enhancement of the central pixel is executed if a value of the central pixel is greater than a predetermined initial threshold, the central pixel value is greater than a value of the upper adjacent pixel, and a difference between the central pixel value and the upper adjacent pixel value is greater than a predetermined judgement threshold.

The bottom-edge detection conditions could be expressed by the following equations.
n(i, j)R>initial threshold (assumed 150) (13)
n(i, j)G>initial threshold (assumed 150) (14)
n(i, j)B>initial threshold (assumed 150) (15)
n(i, j)R>n(i, j−1)R (16)
n(i, j)G>n(i, j−1)G (17)
n(i, j)B>n(i, j−1)B (18)
n(i, j)R−n(i, j−1)R>judgement threshold (assumed 30) (19)
n(i, j)G−n(i, j−1)G>judgement threshold (assumed 30) (20)
n(i, j)B−n(i, j−1)B>judgement threshold (assumed 30) (21)

Where n(i, j)R represents the RGB value of the central pixel at location (i, j) in red, n(i, j)G represents the RGB value of the central pixel at location (i, j) in green, n(i, j)B represents the RGB value of the central pixel at location (i, j) in blue, n(i, j−1)R represents the RGB value of the upper adjacent pixel at location (i−1, j) in red, n(i−1, j)G represents the RGB value of the upper adjacent pixel at location (i−1, j) in green, and n(i−1, j)B represents the RGB value of the upper adjacent pixel at location (i−1, j) in blue.

Therefore, the lightening enhancement of the central pixel at location (i, j) could be expressed by the following equations.
n(i, j)R+a predetermined value (assumed 150) (22)
n(i, j)G+a predetermined value (assumed 150) (23)
n(i, j)B+a predetermined value (assumed 150) (24)

If the pixels do not satisfy the right-edge detection conditions or the lightening enhancement of the central pixel in symbol 104 have been completed, the symbol 104 will perform a left-edge or an upper-edge detection to determine whether the pixels satisfy the necessary conditions or not.

The left-edge detection conditions are described as below. A value of the central pixel at location (i, j) is smaller than a predetermined initial threshold, assumed 150, the central pixel value is smaller than a value of the left adjacent pixel at location (i−1, j), and the absolute value of the difference between the central pixel value at location (i, j) and the left adjacent pixel value at location (i−1, j) is greater than a predetermined judgement threshold. In other words, the RGB value of the central pixel at location (i, j) is smaller than the RGB value of the left adjacent pixel at location (i−1, j) individually. In addition, the absolute value of the difference between the RGB value of the central pixel at location (i, j) and the RGB value of the left adjacent pixel at location (i−1, j) is greater than a predetermined judgement threshold, assumed 30, individually. The edge enhancement is executed by subtracting a predetermined value, assumed 150, from the RGB value of the central pixel at location (i, j) so as to execute darkening enhancement of the central pixel at location (i, j). The left-edge detection conditions could be expressed by the following equations.
n(i, j)R<initial threshold (assumed 150) (25)
n(i, j)G<initial threshold (assumed 150) (26)
n(i, j)B<initial threshold (assumed 150) (27)
n(i, j)R<n(i−1, j)R (28)
n(i, j)G<n(i−1, j)G (29)
n(i, j)B<n(i−1, j)B (30)
|n(i, j)R−n(i−1, j)R|>judgement threshold (assumed 30) (31)
|n(i, j)G−n(i−1, j)G|>judgement threshold (assumed 30) (32)
|n(i, j)B−n(i−1, j)B|>judgement threshold (assumed 30) (33)

Where n(i, j)R represents the RGB value of the central pixel at location (i, j) in red, n(i, j)G represents the RGB value of the central pixel at location (i, j) in green, n(i, j)B represents the RGB value of the central pixel at location (i, j) in blue, n(i−1, j)R represents the RGB value of the left adjacent pixel at location (i−1, j) in red, n(i−1, j)G represents the RGB value of the left adjacent pixel at location (i−1, j) in green, and n(i−1, j)B represents the RGB value of the left adjacent pixel at location (i−1, j) in blue.

Therefore, symbol 104 performs the darkening enhancement of the central pixel at location (i, j) if the pixels satisfy the right-edge detection conditions. The darkening enhancement of the central pixel at location (i, j) could be expressed by the following equations.
n(i, j)R−a predetermined value (assumed 150) (34)
n(i, j)G−a predetermined value (assumed 150) (35)
n(i, j)B−a predetermined value (assumed 150) (36)

The upper-edge detection is similar to the above description. The upper edge is detected and darkening enhancement of the central pixel is executed if a value of the central pixel is smaller than a predetermined initial threshold, the central pixel value is smaller than a value of the upper adjacent pixel, and the absolute value of the difference between the central pixel value and the upper adjacent pixel value is greater than a predetermined judgement threshold.

The upper-edge detection conditions could be expressed by the following equations.
n(i, j)R<initial threshold (assumed 150) (37)
n(i, j)G<initial threshold (assumed 150) (38)
n(i, j)B<initial threshold (assumed 150) (39)
n(i, j)R<n(i, j−1)R (40)
n(i, j)G<n(i, j−1)G (41)
n(i, j)B<n(i, j−1)B (42)
|n(i, j)R−n(i, j−1)R|>judgement threshold (assumed 30) (43)
|n(i, j)G−n(i, j−1)G|>judgement threshold (assumed 30) (44)
|n(i, j)B−n(i, j−1)B|>judgement threshold (assumed 30) (45)

Where n(i, j)R represents the RGB value of the central pixel at location (i, j) in red, n(i, j)G represents the RGB value of the central pixel at location (i, j) in green, n(i, j)B represents the RGB value of the central pixel at location (i, j) in blue, n(i, j−1)R represents the RGB value of the upper adjacent pixel at location (i, j−1) in red, n(i, j−1)G represents the RGB value of the upper adjacent pixel at location (i, j−1) in green, and n(i, j−1)B represents the RGB value of the upper adjacent pixel at location (i, j−1) in blue.

Therefore, the lightening enhancement of the central pixel at location (i, j) could be expressed by the following equations.
n(i, j)R−a predetermined value (assumed 150) (46)
n(i, j)G−a predetermined value (assumed 150) (47)
n(i, j)B−a predetermined value (assumed 150) (48)

Symbol 107 gets the result from symbol 105 or symbol 106 and then darkens the text interior pixel to emphasize the contrast between the text pixel and the background pixel if the pixel is recognized as the text interior pixel within the area of the edge pixels in the dark-text light-background system. In other words, the RGB values in the text interior pixel are decreased so as to emphasize the contrast between the text pixel and the background pixel. Symbol 108 is the re-normalization procedure which is utilized to reset the RGB values of the pixels so as to prevent the RGB values of the pixels from exceeding the RGB range of (0, 0, 0) to (255, 255, 255). For example, during the lightening enhancement or the darkening enhancement, the RGB values of the central pixel at location (i, j) maybe exceeds the maximum values (255, 255, 255) or are lower than the minimum values (0, 0, 0) so the re-normalization procedure is necessary. The re-normalization procedure is described as follows. If the RGB values of the central pixel at location (i, j) exceed the maximum values (255, 255, 255) during the lightening enhancement, the RGB values of the central pixel at location (i, j) is set to (255, 255, 255). If the RGB values of the central pixel at location (i, j) are lower than the minimum values (0, 0, 0) during the darkening enhancement, the RGB values of the central pixel at location (i, j) is set to (0, 0, 0).

Symbol 109 gets the result from symbol 108 and decides whether getting more pixels is necessary or not. If getting more pixels is necessary, the procedure of symbols 102 to symbol 108 will be repeated again. If getting more pixels is not necessary, the text enhancement procedure of symbols 102 to symbol 108 will be not repeated again. In other words, the text enhancement procedure will be terminated.

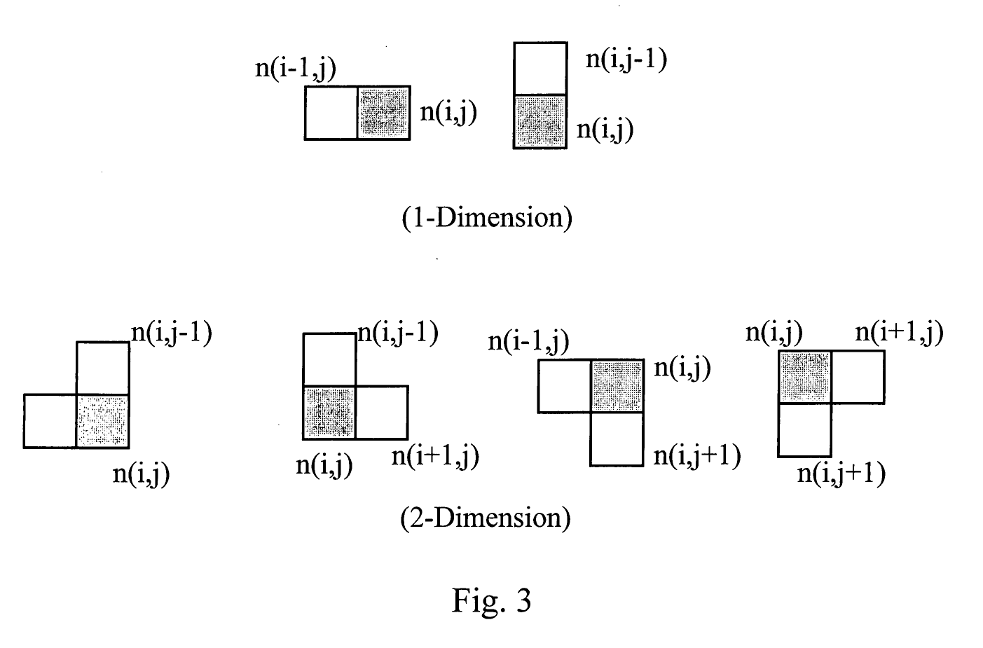

Please refer to FIG. 3 which is a possible set of window blocks of the text enhancement methodology of gray-scale levels of a scanned image with a white background (or light background) in RGB domain or solely gray-scale domain according to a preferred embodiment of the present invention. The window block could be a 2-pixel in-line shape window block or a three-pixel window block. The three-pixel window block could be a mirrored 3-pixel L-shape window block comprising a central pixel, an upper adjacent pixel, and a left adjacent pixel, a 3-pixel L-shape window block comprising a central pixel, an upper adjacent pixel, and a right adjacent pixel, an inverse 3-pixel L-shape window block comprising a central pixel, a lower adjacent pixel, and a right adjacent pixel, and a mirrored inverse 3-pixel L-shape window block comprising a central pixel, a lower adjacent pixel, and a left adjacent pixel.

The two-pixel window block could be divided into four groups consisting of: A). a right edge two-pixel window block comprising a right adjacent pixel, and a left adjacent pixel, wherein a right edge is detected and lightening enhancement of the right adjacent pixel is executed if a value of the right adjacent pixel is greater than a predetermined initial threshold, the right adjacent pixel value is greater than a value of the left adjacent pixel, and a difference between the right adjacent pixel value and the left adjacent pixel value is greater than a predetermined judgement threshold; B). a left-edge two-pixel window block comprising a right adjacent pixel, and a left adjacent pixel, wherein a left-edge is detected and darkening enhancement of the right adjacent pixel is executed if a value of the right adjacent pixel is smaller than the predetermined initial threshold, the right adjacent pixel value is smaller than a value of the left adjacent pixel, and an absolute value of a difference between the right adjacent pixel value and the left adjacent pixel value is greater than the predetermined judgement threshold; C). an upper-edge two-pixel window block comprising an upper adjacent pixel, and a lower adjacent pixel, wherein an upper-edge is detected and lightening enhancement of the upper adjacent pixel is executed if a value of the upper adjacent pixel is greater than the predetermined initial threshold, the upper adjacent pixel value is greater than a value of the lower adjacent pixel, and an absolute value of a difference between the upper adjacent pixel value and the lower adjacent pixel value is greater than the predetermined judgement threshold; and D). a bottom edge two-pixel window block comprising an upper adjacent pixel, and a lower adjacent pixel, wherein a bottom edge is detected and darkening enhancement of the upper adjacent pixel is executed if a value of the upper adjacent pixel is smaller than the predetermined initial threshold, the upper adjacent pixel value is smaller than a value of the lower adjacent pixel, and an absolute value of a difference between the upper adjacent pixel value and the lower adjacent pixel value is greater than the predetermined judgement threshold.

If the right edge or the upper edge is detected, the darkening enhancement will be executed when the three-pixel window block is a 3-pixel L-shape window block. If the left edge or the bottom edge is detected, the lightening enhancement will be executed when the three-pixel window block is a 3-pixel L-shape window block.

If the right edge or the upper edge is detected, the lightening enhancement will be executed when the three-pixel window block is an inverse 3-pixel L-shape window block. If the left edge or the bottom edge is detected, the darkening enhancement will be executed when the three-pixel window block is an inverse 3-pixel L-shape window block.

If the right edge or the bottom edge is detected, the darkening enhancement will be executed when the three-pixel window block is a mirrored inverse 3-pixel L-shape window block. If the left edge or the upper edge is detected, the lightening enhancement will be executed when the three-pixel window block is a mirrored inverse 3-pixel L-shape window block.

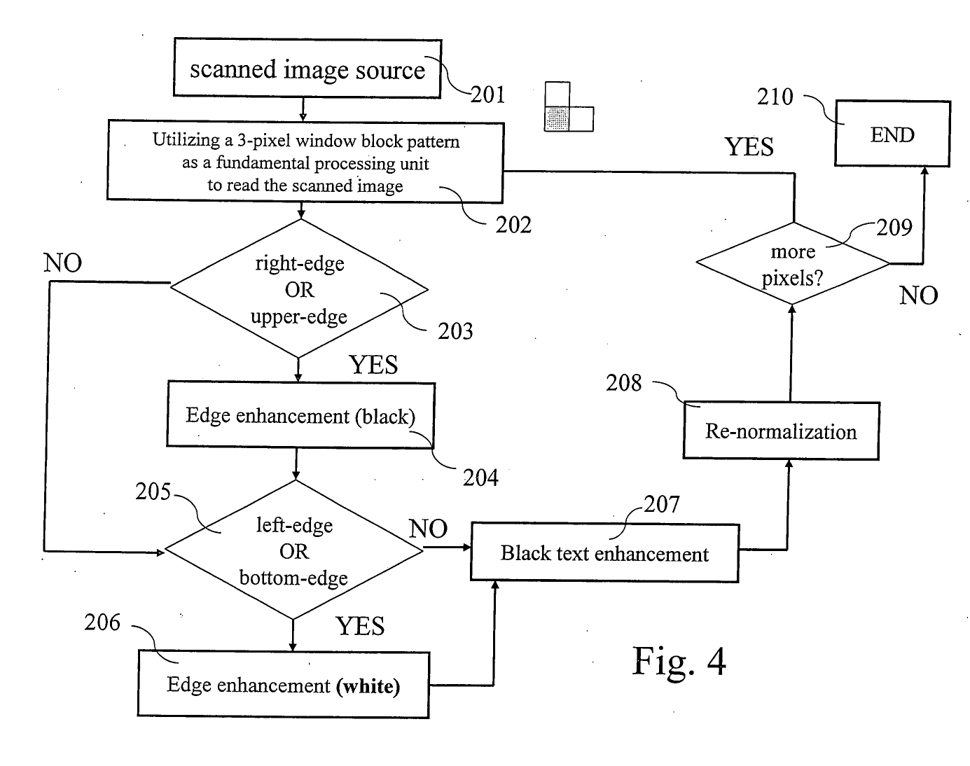

Please refer to FIG. 4 which is an alternative flowchart of the text enhancement methodology of gray-scale levels of a scanned image with a white background (or light background) in RGB domain or solely gray-scale domain according to a preferred embodiment of the present invention. No matter the first-stage edge detection could perform a darkening function and the second-stage edge detection could perform a lightening function, or vice versa, the first-stage edge detection performs the lightening function and the second-stage edge detection performs the darkening function, the change of the order of the procedures has no influence on the consequence of the text enhancement methodology.

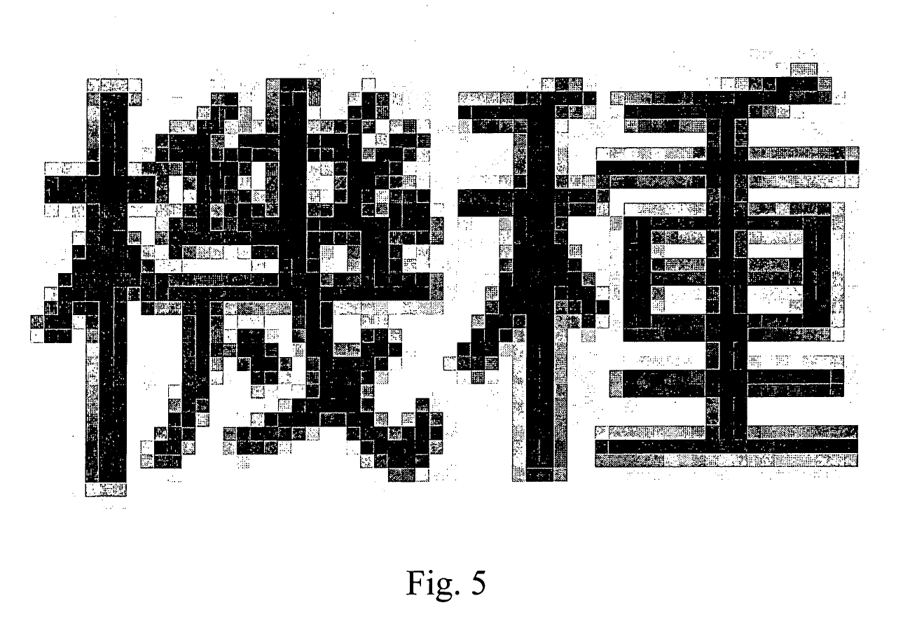

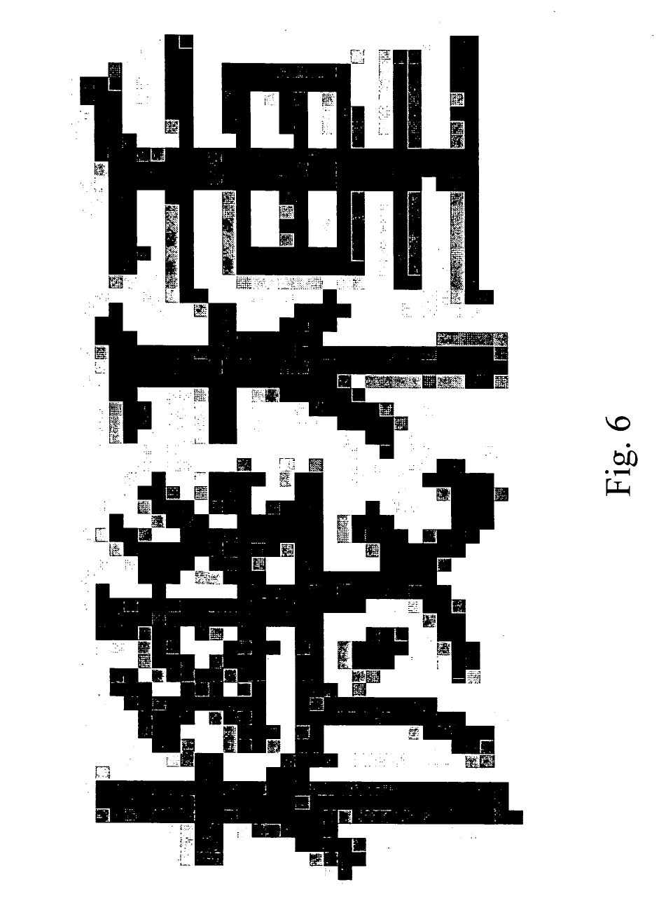

Please refer to FIG. 5 which is an unprocessed source image and FIG. 6 which is an enhanced image with the text methodology of the present invention. It is very apparent that the enhanced image with the text methodology of the present invention is clearer than the unprocessed source image.

The above examples use a dark-text light-background system to illustrate the embodiments of the invention. Nevertheless, the application of this invention is not limited to the dark-text light-background system. The invention could also be adapted to a light-text dark-background system. Although the present invention has been described in terms of the text enhancement methodology of gray-scale levels of a scanned image with a white background (or light background) in RGB domain (three-component-per-pixel), it can readily be adapted to solely gray-scale domain (single-component-per-pixel).

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Additionally, the abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

What is claimed is:

1. A text enhancement methodology of gray-scale levels of a scanned image, comprising the steps of:
e) utilizing a window block pattern as a fundamental processing unit to read said scanned image, wherein said window block pattern comprises at least two pixels in a predetermined neighborhood;
f) analyzing said scanned image in said window block pattern to find right, left, upper, and bottom edges;
g) labeling said image in said window block pattern as two groups of text pixels and non-text pixels based on said window block pattern and said right, left, upper, and bottom edges; and
h) enhancing said text pixels/non-text pixels of scanned image in said window block pattern based on said window block pattern and said right, left, upper, and bottom edges.

2. The methodology, as recited in claim 1, wherein said window block size is selected from one of a two-pixel window block and a three-pixel window block.

3. The methodology, as recited in claim 1, wherein said window block shape is selected from a group consisting of a 2-pixel in-line shape window block, a 3-pixel L-shape window block, a mirrored 3-pixel L-shape window block, an inverse 3-pixel L-shape window block, and a mirrored inverse 3-pixel L-shape window block.

4. The methodology, as recited in claim 2, wherein said three-pixel window block is selected from four groups consisting of:
A). a mirrored 3-pixel L-shape window block comprising a central pixel, an upper adjacent pixel, and a left adjacent pixel;
B). a 3-pixel L-shape window block comprising a central pixel, an upper adjacent pixel, and a right adjacent pixel;
C). an inverse 3-pixel L-shape window block comprising a central pixel, a lower adjacent pixel, and a right adjacent pixel; and
D). a mirrored inverse 3-pixel L-shape window block comprising a central pixel, a lower adjacent pixel, and a left adjacent pixel.

5. The methodology, as recited in claim 4, wherein a right edge is detected and lightening enhancement of said central pixel is executed if a value of said central pixel is greater than a predetermined initial threshold, said central pixel value is greater than a value of said left adjacent pixel, and a difference between said central pixel value and said left adjacent pixel value is greater than a predetermined judgement threshold when said mirrored 3-pixel L-shape window block is utilized.

6. The methodology, as recited in claim 4, wherein a bottom edge is detected and lightening enhancement of said central pixel is executed if a value of said central pixel is greater than a predetermined initial threshold, said central pixel value is greater than a value of said upper adjacent pixel, and a difference between said central pixel value and said upper adjacent pixel value is greater than a predetermined judgement threshold when said mirrored 3-pixel L-shape window block is utilized.

7. The methodology, as recited in claim 4, wherein a left-edge is detected and darkening enhancement of said central pixel is executed if a value of said central pixel is smaller than a predetermined initial threshold, said central pixel value is smaller than a value of said left adjacent pixel, and an absolute value of a difference between said central pixel value and said left adjacent pixel value is greater than a predetermined judgement threshold when said mirrored 3-pixel L-shape window block is utilized.

8. The methodology, as recited in claim 4, wherein an upper-edge is detected and darkening enhancement of said central pixel is executed if a value of said central pixel is smaller than a predetermined initial threshold, said central pixel value is smaller than a value of said upper adjacent pixel, and an absolute value of a difference between said central pixel value and said upper adjacent pixel value is greater than a predetermined judgement threshold when said mirrored 3-pixel L-shape window block is utilized.

9. The methodology, as recited in claim 4, wherein a right edge is detected and darkening enhancement of said central pixel is executed if a value of said central pixel is smaller than a predetermined initial threshold, said central pixel value is smaller than a value of said right adjacent pixel, and an absolute value of a difference between said central pixel value and said right adjacent pixel value is greater than a predetermined judgement threshold when said 3-pixel L-shape window block is utilized.

10. The methodology, as recited in claim 4, wherein a bottom edge is detected and lightening enhancement of said central pixel is executed if a value of said central pixel is greater than a predetermined initial threshold, said central pixel value is greater than a value of said upper adjacent pixel, and a difference between said central pixel value and said upper adjacent pixel value is greater than a predetermined judgement threshold when said 3-pixel L-shape window block is utilized.

11. The methodology, as recited in claim 4, wherein a left-edge is detected and lightening enhancement of said central pixel is executed if a value of said central pixel is greater than a predetermined initial threshold, said central pixel value is greater than a value of said right adjacent pixel, and a difference between said central pixel value and said right adjacent pixel value is greater than a predetermined judgement threshold when said 3-pixel L-shape window block is utilized.

12. The methodology, as recited in claim 4, wherein an upper-edge is detected and darkening enhancement of said central pixel is executed if a value of said central pixel is smaller than a predetermined initial threshold, said central pixel value is smaller than a value of said upper adjacent pixel, and an absolute value of a difference between said central pixel value and said upper adjacent pixel value is greater than a predetermined judgement threshold when said 3-pixel L-shape window block is utilized.

13. The methodology, as recited in claim 4, wherein a right edge is detected and darkening enhancement of said central pixel is executed if a value of said central pixel is smaller than a predetermined initial threshold, said central pixel value is smaller than a value of said right adjacent pixel, and an absolute value of a difference between said central pixel value and said right adjacent pixel value is greater than a predetermined judgement threshold when said inverse 3-pixel L-shape window block is utilized.

14. The methodology, as recited in claim 4, wherein a bottom edge is detected and darkening enhancement of said central pixel is executed if a value of said central pixel is smaller than a predetermined initial threshold, said central pixel value is smaller than a value of said lower adjacent pixel, and an absolute value of a difference between said central pixel value and said lower adjacent pixel value is greater than a predetermined judgement threshold when said inverse 3-pixel L-shape window block is utilized.

15. The methodology, as recited in claim 4, wherein a left-edge is detected and lightening enhancement of said central pixel is executed if a value of said central pixel is greater than a predetermined initial threshold, said central pixel value is greater than a value of said right adjacent pixel, and a difference between said central pixel value and said right adjacent pixel value is greater than a predetermined judgement threshold when said inverse 3-pixel L-shape window block is utilized.

16. The methodology, as recited in claim 4, wherein an upper-edge is detected and lightening enhancement of said central pixel is executed if a value of said central pixel is greater than a predetermined initial threshold, said central pixel value is greater than a value of said lower adjacent pixel, and a difference between said central pixel value and said lower adjacent pixel value is greater than a predetermined judgement threshold when said inverse 3-pixel L-shape window block is utilized.

17. The methodology, as recited in claim 4, wherein a right edge is detected and lightening enhancement of said central pixel is executed if a value of said central pixel is greater than a predetermined initial threshold, said central pixel value is greater than a value of said left adjacent pixel, and a difference between said central pixel value and said left adjacent pixel value is greater than a predetermined judgement threshold when said mirrored inverse 3-pixel L-shape window block is utilized.

18. The methodology, as recited in claim 4, wherein a bottom edge is detected and darkening enhancement of said central pixel is executed if a value of said central pixel is smaller than a predetermined initial threshold, said central pixel value is smaller than a value of said lower adjacent pixel, and an absolute value of a difference between said central pixel value and said lower adjacent pixel value is greater than a predetermined judgement threshold when said mirrored inverse 3-pixel L-shape window block is utilized.

19. The methodology, as recited in claim 4, wherein a left-edge is detected and darkening enhancement of said central pixel is executed if a value of said central pixel is smaller than a predetermined initial threshold, said central pixel value is smaller than a value of said left adjacent pixel, and an absolute value of a difference between said central pixel value and said left adjacent pixel value is greater than a predetermined judgement threshold when said mirrored inverse 3-pixel L-shape window block is utilized.

20. The methodology, as recited in claim 4, wherein an upper-edge is detected and lightening enhancement of said central pixel is executed if a value of said central pixel is greater than a predetermined initial threshold, said central pixel value is greater than a value of said lower adjacent pixel, and a difference between said central pixel value and said lower adjacent pixel value is greater than a predetermined judgement threshold when said mirrored inverse 3-pixel L-shape window block is utilized.

21. The methodology, as recited in claim 2, wherein said two-pixel window block is selected from four groups consisting of:
A). a right edge two-pixel window block comprising a right adjacent pixel, and a left adjacent pixel, wherein a right edge is detected and lightening enhancement of said right adjacent pixel is executed if a value of said right adjacent pixel is greater than a predetermined initial threshold, said right adjacent pixel value is greater than a value of said left adjacent pixel, and a difference between said right adjacent pixel value and said left adjacent pixel value is greater than a predetermined judgement threshold;
B). a left-edge two-pixel window block comprising a right adjacent pixel, and a left adjacent pixel, wherein a left-edge is detected and darkening enhancement of said right adjacent pixel is executed if a value of said right adjacent pixel is smaller than said predetermined initial threshold, said right adjacent pixel value is smaller than a value of said left adjacent pixel, and an absolute value of a difference between said right adjacent pixel value and said left adjacent pixel value is greater than said predetermined judgement threshold;
C). an upper-edge two-pixel window block comprising an upper adjacent pixel, and a lower adjacent pixel, wherein an upper-edge is detected and lightening enhancement of said upper adjacent pixel is executed if a value of said upper adjacent pixel is greater than said predetermined initial threshold, said upper adjacent pixel value is greater than a value of said lower adjacent pixel, and an absolute value of a difference between said upper adjacent pixel value and said lower adjacent pixel value is greater than said predetermined judgement threshold; and
D). a bottom edge two-pixel window block comprising an upper adjacent pixel, and a lower adjacent pixel, wherein a bottom edge is detected and darkening enhancement of said upper adjacent pixel is executed if a value of said upper adjacent pixel is smaller than said predetermined initial threshold, said upper adjacent pixel value is smaller than a value of said lower adjacent pixel, and an absolute value of a difference between said upper adjacent pixel value and said lower adjacent pixel value is greater than said predetermined judgement threshold.

22. A system for enhancing text of gray-scale levels in a scanned image, comprising:
means for utilizing a window block pattern as a fundamental processing unit to read said scanned image, wherein said window block pattern comprises at least two pixels in a predetermined neighborhood;
means for analyzing said scanned image in said window block pattern to find right, left, upper, and bottom edges;
means for labeling said image in said window block pattern as two groups of text pixels and non-text pixels based on said window block pattern and said right, left, upper, and bottom edges; and
means for enhancing said text pixels/non-text pixels of scanned image in said window block pattern based on said window block pattern and said right, left, upper, and bottom edges.

23. The system, as recited in claim 22, wherein said window block shape is selected from a group consisting of a 2-pixel in-line shape window block, a 3-pixel L-shape window block, a mirrored 3-pixel L-shape window block, an inverse 3-pixel L-shape window block, and a mirrored inverse 3-pixel L-shape window block.

24. The system, as recited in claim 22, wherein said window block shape is selected from a group consisting of a 2-pixel in-line shape window block, a 3-pixel L-shape window block, a mirrored 3-pixel L-shape window block, an inverse 3-pixel L-shape window block, and a mirrored inverse 3-pixel L-shape window block.

25. The system, as recited in claim 23, wherein said three-pixel window block is selected from four groups consisting of:
A). a mirrored 3-pixel L-shape window block comprising a central pixel, an upper adjacent pixel, and a left adjacent pixel;
B). a 3-pixel L-shape window block comprising a central pixel, an upper adjacent pixel, and a right adjacent pixel;
C). an inverse 3-pixel L-shape window block comprising a central pixel, a lower adjacent pixel, and a right adjacent pixel; and
D). a mirrored inverse 3-pixel L-shape window block comprising a central pixel, a lower adjacent pixel, and a left adjacent pixel.

26. The system, as recited in claim 25, wherein a right edge is detected and lightening enhancement of said central pixel is executed if a value of said central pixel is greater than a predetermined initial threshold, said central pixel value is greater than a value of said left adjacent pixel, and a difference between said central pixel value and said left adjacent pixel value is greater than a predetermined judgement threshold when said mirrored 3-pixel L-shape window block is utilized.

27. The system, as recited in claim 25, wherein a bottom edge is detected and lightening enhancement of said central pixel is executed if a value of said central pixel is greater than a predetermined initial threshold, said central pixel value is greater than a value of said upper adjacent pixel, and a difference between said central pixel value and said upper adjacent pixel value is greater than a predetermined judgement threshold when said mirrored 3-pixel L-shape window block is utilized.

28. The system, as recited in claim 25, wherein a left-edge is detected and darkening enhancement of said central pixel is executed if a value of said central pixel is smaller than a predetermined initial threshold, said central pixel value is smaller than a value of said left adjacent pixel, and an absolute value of a difference between said central pixel value and said left adjacent pixel value is greater than a predetermined judgement threshold when said mirrored 3-pixel L-shape window block is utilized.

29. The system, as recited in claim 25, wherein an upper-edge is detected and darkening enhancement of said central pixel is executed if a value of said central pixel is smaller than a predetermined initial threshold, said central pixel value is smaller than a value of said upper adjacent pixel, and an absolute value of a difference between said central pixel value and said upper adjacent pixel value is greater than a predetermined judgement threshold when said mirrored 3-pixel L-shape window block is utilized.

30. The system, as recited in claim 25, wherein a right edge is detected and darkening enhancement of said central pixel is executed if a value of said central pixel is smaller than a predetermined initial threshold, said central pixel value is smaller than a value of said right adjacent pixel, and an absolute value of a difference between said central pixel value and said right adjacent pixel value is greater than a predetermined judgement threshold when said 3-pixel L-shape window block is utilized.

31. The system, as recited in claim 25, wherein a bottom edge is detected and lightening enhancement of said central pixel is executed if a value of said central pixel is greater than a predetermined initial threshold, said central pixel value is greater than a value of said upper adjacent pixel, and a difference between said central pixel value and said upper adjacent pixel value is greater than a predetermined judgement threshold when said 3-pixel L-shape window block is utilized.

32. The system, as recited in claim 25, wherein a left-edge is detected and lightening enhancement of said central pixel is executed if a value of said central pixel is greater than a predetermined initial threshold, said central pixel value is greater than a value of said right adjacent pixel, and a difference between said central pixel value and said right adjacent pixel value is greater than a predetermined judgement threshold when said 3-pixel L-shape window block is utilized.

33. The system, as recited in claim 25, wherein an upper-edge is detected and darkening enhancement of said central pixel is executed if a value of said central pixel is smaller than a predetermined initial threshold, said central pixel value is smaller than a value of said upper adjacent pixel, and an absolute value of a difference between said central pixel value and said upper adjacent pixel value is greater than a predetermined judgement threshold when said 3-pixel L-shape window block is utilized.

34. The system, as recited in claim 25, wherein a right edge is detected and darkening enhancement of said central pixel is executed if a value of said central pixel is smaller than a predetermined initial threshold, said central pixel value is smaller than a value of said right adjacent pixel, and an absolute value of a difference between said central pixel value and said right adjacent pixel value is greater than a predetermined judgement threshold when said inverse 3-pixel L-shape window block is utilized.

35. The system, as recited in claim 25, wherein a bottom edge is detected and darkening enhancement of said central pixel is executed if a value of said central pixel is smaller than a predetermined initial threshold, said central pixel value is smaller than a value of said lower adjacent pixel, and an absolute value of a difference between said central pixel value and said lower adjacent pixel value is greater than a predetermined judgement threshold when said inverse 3-pixel L-shape window block is utilized.

36. The system, as recited in claim 25, wherein a left-edge is detected and lightening enhancement of said central pixel is executed if a value of said central pixel is greater than a predetermined initial threshold, said central pixel value is greater than a value of said right adjacent pixel, and a difference between said central pixel value and said right adjacent pixel value is greater than a predetermined judgement threshold when said inverse 3-pixel L-shape window block is utilized.

37. The system, as recited in claim 25, wherein an upper-edge is detected and lightening enhancement of said central pixel is executed if a value of said central pixel is greater than a predetermined initial threshold, said central pixel value is greater than a value of said lower adjacent pixel, and a difference between said central pixel value and said lower adjacent pixel value is greater than a predetermined judgement threshold when said inverse 3-pixel L-shape window block is utilized.

38. The system, as recited in claim 25, wherein a right edge is detected and lightening enhancement of said central pixel is executed if a value of said central pixel is greater than a predetermined initial threshold, said central pixel value is greater than a value of said left adjacent pixel, and a difference between said central pixel value and said left adjacent pixel value is greater than a predetermined judgement threshold when said mirrored inverse 3-pixel L-shape window block is utilized.

39. The system, as recited in claim 25, wherein a bottom edge is detected and darkening enhancement of said central pixel is executed if a value of said central pixel is smaller than a predetermined initial threshold, said central pixel value is smaller than a value of said lower adjacent pixel, and an absolute value of a difference between said central pixel value and said lower adjacent pixel value is greater than a predetermined judgement threshold when said mirrored inverse 3-pixel L-shape window block is utilized.

40. The system, as recited in claim 25, wherein a left-edge is detected and darkening enhancement of said central pixel is executed if a value of said central pixel is smaller than a predetermined initial threshold, said central pixel value is smaller than a value of said left adjacent pixel, and an absolute value of a difference between said central pixel value and said left adjacent pixel value is greater predetermined judgement threshold when said mirrored inverse 3-pixel L-shape window block is utilized.

41. The system, as recited in claim 25, wherein an upper-edge is detected and lightening enhancement of said central pixel is executed if a value of said central pixel is greater than a predetermined initial threshold, said central pixel value is greater than a value of said lower adjacent pixel, and a difference between said central pixel value and said lower adjacent pixel value is greater than a predetermined judgement threshold when said mirrored inverse 3-pixel L-shape window block is utilized.
